(19) United States
(12) Patent Application Publication
(10) Pub. No.: US 2012/0230057 A1
(43) Pub. Date: Sep. 13, 2012

(54) LED READING LIGHT

(75) Inventors: Eric Braden, Fountain Valley, CA (US); Jaehwan Park, Ansan-Si (KR)

(73) Assignee: WAMCO, INC., Fountain Valley, CA (US)

(21) Appl. No.: 13/413,240

(22) Filed: Mar. 6, 2012

Related U.S. Application Data
(60) Provisional application No. 61/451,178, filed on Mar. 10, 2011.

(51) Int. Cl. F21V 5/04; F21V 29/00; H01R 33/02

(52) U.S. Cl. 362/640; 362/311.02

(57) ABSTRACT

A drop-in assembly which fits in the socket of an existing reading light. The assembly comprises a truncated cone of plastic or other translucent material which transmits light generated by an LED light source. The assembly has a central core of air surrounded by the plastic material and at a wide end of the assembly and positioned over a central core is a disk of diffusing material. At a narrow end of the assembly is a metal structure which fits into the existing socket structure and functions as both an electrical contact and a heat transfer element which promotes dissipation of heat generated by the LED light source

### CROSS-REFERENCE TO RELATED APPLICATIONS

This application claims the benefit of U.S. Provisional Application No. 61/451,178, filed Mar. 10, 2011, of which the entirety is incorporated herein by reference.

### STATEMENT REGARDING FEDERALLY SPONSORED RESEARCH OR DEVELOPMENT

Not applicable.

### REFERENCE TO A SEQUENCE LISTING, TABLE, OR COMPUTER PROGRAM APPENDIX

Not applicable.

### BACKGROUND OF THE INVENTION

1. Field of the Invention

The present invention relates to a light emitting diode (“LED”) reading light for use in airplanes, trains, buses and other modes of transportation as a replacement for existing reading lights using incandescent, halogen or other light sources.

2. Description of Related Art

Traditionally, individual reading lights have been located above the passenger seats in airplanes, trains, buses and other modes of transportation to allow passengers to read material of interest to them while minimizing the disturbance of surrounding passengers. These individual reading lights typically include a light source, a lens or focusing system to focus the light beam from the light source on the appropriate passenger seat, electrical connections to the electrical system of the vehicle in which the reading light is located to provide power to the light source, and thermal contacts or a heat sink to handle the heat generated by the light source.

Initially, the light source was an incandescent bulb and the fixture or socket in the vehicle was designed specifically to accept the reading light. However, the use of incandescent light sources created various problems, the most significant of which were the heat generated by the incandescent light source, the power used by the incandescent light source, and the relatively short life of the light. Other problems included the color spectrum of the light generated by the incandescent light source, the variation of the spectrum over time and the shape of the light beam generated. In addition, incandescent lights were fragile.

The power requirements of incandescent light sources, which are known to be inefficient sources of light, imposed significant burdens on the power generation systems of the vehicle in which the lights were included requiring larger power generation systems which in turn increased the weight of the vehicle and the consumption of fuel to power the vehicle including its power generation system. In addition, the heat generated by the incandescent light sources imposed a burden on the air conditioning systems of the vehicles in which the lights were included requiring larger air conditioning systems which in turn increased the power generation requirements of the vehicle and, consequently, its weight and, therefore, its fuel consumption. The relatively short life of the incandescent light sources required frequent and costly replacements. The variation in the intensity and spectrum of the light generated by incandescent lights over time often rendered the light generated uncomfortable for the reader.

As lighting technology developed, different kinds of light sources, such as halogen light sources, were adopted as reading lights. These new light sources addressed, to a certain extent, some of the problems with incandescent light sources. They used somewhat less power, produced somewhat less heat, and had somewhat longer lives. However, they were still fragile.

Within the last few years, light emitting diode (“LED”) technology has advanced substantially. LEDs, which began as novelty items, became increasing powerful light sources, cheaper to manufacture, and more reliable. They were adopted for use as indicator lamps, then as displays in calculators and other small devices, then as light sources in small flashlights and other illuminating devices, and are now being adopted as major sources of illumination.

LEDs offer many advantages over other light sources. LEDs consume substantially less power than other light sources. LEDs produce substantially less heat than other light sources. LEDs have substantially longer lives than other light sources. The spectrum of the light generated by LEDs can be readily controlled and remains relatively constant over time. LED light fixtures are lighter than other types of light fixtures, are less fragile and are easier to handle. In short, LEDs represent a substantial improvement over other types of light sources.

With the development of LED technology, LEDs began being used in a number of applications which had previously been the domain of incandescent, halogen or other light sources. Specifically, LEDs are now used extensively in automobiles not only for indicators and interior lighting but for exterior lighting as well. In fact, LEDs are now being used in headlights as the sole source of light.

With the development of LED technology and the ever expanding application of LED light sources, the benefits of employing LEDs as reading lights in airplanes, trains, buses and other kinds of vehicles were recognized. However, there were issues associated with using LEDs as reading lights in such vehicles. Those vehicles are large, expensive and time consuming to design and build, and have very long product cycles and useful lives. Accordingly, redesigning the lighting fixtures of an airplane to utilize LED light sources would be a time consuming, expensive and ultimately less than optimal way to incorporate LED reading lights.

Consequently, it would be desirable to be able to replace an existing incandescent or halogen reading light by inserting an LED reading light into the existing socket without having to make any modifications to the existing socket, the vehicle's electrical system or heat dissipating facilities.

### BRIEF SUMMARY OF THE INVENTION

An object of the present invention is to provide an LED reading light that can directly replace an existing incandescent, halogen or other reading light as a drop-in replacement without having to modify the socket of the existing reading light. A further object of the invention is to provide an LED reading light in which the socket base serves as both a heat sink and an electrical connection for the LED, thus eliminating the need for a dedicated heat sink.

An additional object of this invention is to provide an LED reading light that effectively focuses the light generated by the LED light source in a relatively narrow, sharp-edged, uniform beam without a halo.

The present invention comprises a drop-in assembly which fits in the socket of an existing reading light. The assembly comprises a truncated cone of plastic or other translucent material which will transmit light generated by the LED light source. The assembly has a central core of air surrounded by the plastic material. At the wide end of the assembly and positioned over the central core is a disk of diffusing material. At the narrow end of the assembly is a metal structure which fits into the existing socket structure and functions as both an electrical contact and a heat transfer element which helps to dissipate heat generated by the LED light source.

### BRIEF DESCRIPTION OF THE SEVERAL VIEWS OF THE DRAWING

FIG. 1 is a cross sectional view of the light assembly illustrating the light transmitting portion of the assembly including the central core with the diffusing disk in the center of the exterior surface;

FIG. 2 is a cross sectional view of the metal structure which serves both to dissipate heat and to provide power to the LED light source; and

FIG. 3 is a top view of the assembly showing the diffusing disk located in the center of the surface of the assembly.

### DETAILED DESCRIPTION OF THE INVENTION

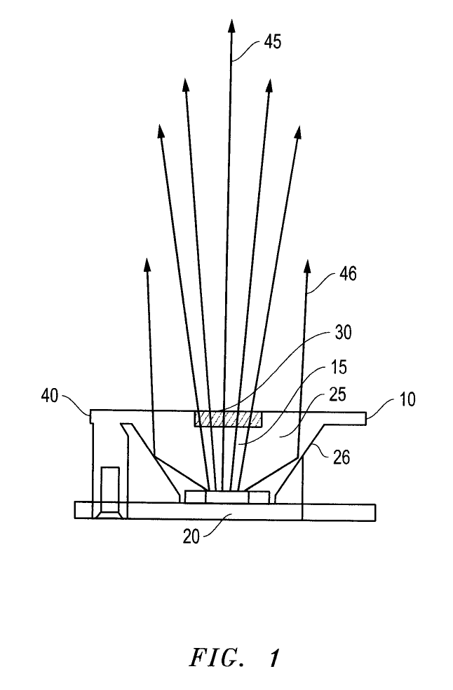

Referring to FIG. 1, the figure illustrates the paths of light rays from an LED light source 20 as they pass through an assembly 40 and are focused on the desired location. In FIG. 1, the LED light source 20 is located at the narrow end of a truncated cone 10. The truncated cone 10 comprises a central core of air 15 surrounded by plastic or other material 25 appropriate for use as a lens. The plastic 25 may be acrylic, polycarbonate (PC) or poly(methyl methacrylate) (PMMA). PC is preferable because of its hardness. At the wide end of the cone opposite the LED light source 20, a surface 30 comprises a diffusing material with a textured surface which serves to smooth the beam of light emitted by the device.

As shown in FIG. 3, at the center of the surface 30 of the assembly 40 there is a concentric diffuser disk 35 of diffusing material which serves to scatter the light rays coming through the central core. The concentric diffuser disk 35 fits in a hole in the surface and may be attached to the surface 30 of the assembly using a pressure fit or it may be attached using glue. However, if glue is used, the glue may affect the light transmission properties of the assembly 40.

The diffusing material of the surface 30 of the assembly 40 acts in conjunction with the concentric diffuser disk 35 to smooth the beam pattern of the light emitted by the device, to eliminate any halo to the light beam, and to create a relatively sharp edge to the beam.

Light emitting from the LED light source 20 follows multiple paths. Several examples of those paths are shown in FIG. 1 for illustrative purposes. Light beam 45, representative of the many light beams emitted from the LED light source 20 which travel undeflected through the air core 15, travels from the LED light source 20 in a relatively straight path from the LED light source 20 through the air core 15 to the concentric diffuser disk 35. At the concentric diffuser disk 35 the light beam 45 is diffused into multiple beams resulting in a smoothing of the beam patterns.

Light beam 46, representative of the many light beams emitted from the LED light source 20 which do not travel undeflected through the air core 15 to the diffuser disk 35 will at some point hit the boundary between the air core 15 and the plastic material 25 comprising the bulk of the lens. Depending on the nature of the material 25, its index of refraction, and the angle of incidence of the light beam on the boundary, some of the light in light beam 46 will be refracted into the plastic material 25 of the lens and will travel until it hits the outside edge 26 of the lens at which point it will be reflected upward through the surface of the assembly 40 to become part of a light beam emanating from the assembly 40. The edge 26 of the assembly 40 acts as a total internal reflection surface (TIR) and serves to replace the metalized reflectors in the existing incandescent or halogen fixture.

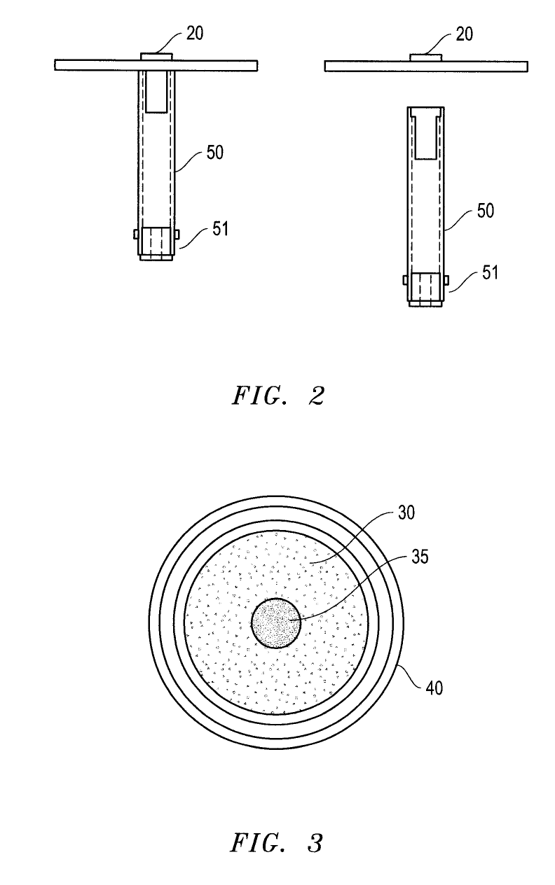

As shown in FIG. 2, attached to the narrow end of the cone 10, in the vicinity of the LED light source 20 is a metal structure 50 which serves as a bayonet mount to facilitate the attachment of the LED light source 20 to the existing light socket. The metal structure 50 may have components 51 to assist in attaching the LED assembly 40 to the existing socket. The structure 50 provides an electrical contact to the existing electrical circuit of the airplane, train or bus to provide power and control functions and also serves to dissipate heat generated by the LED light source 20.

1. (canceled)

2. An LED light assembly comprising:
an LED light source;
a lens assembly disposed with the LED source, wherein the lens assembly comprises a truncated cone having a central core of air surrounded by a preselected material for use as a lens, wherein the LED light source is disposed near a narrow end of the cone;
a substantially textured diffusing surface disposed at a wide end of the truncated cone;
a concentric diffuser disposed with the substantially flat textured diffusing surface and opposite the LED light source; and
a conductive metal structure attached near the LED light source of the lens assembly.

3. The LED light assembly as in claim 2, wherein the preselected material for use as a lens is a plastic selected from the group consisting of acrylic, polycarbonate (PC), and polymethylmethacrylate (PMMA).

4. The LED light assembly as in claim 2, wherein the concentric diffuser has a textured surface, whereby the substantially textured diffusing surface and the concentric diffuser act in conjunction to smooth the beam pattern of the light emitted from the LED light source to eliminate halo effect.

5. The LED light assembly as in claim 2, wherein edges of the truncated cone create a total internal reflection surface (TIR).

6. The LED light assembly as in claim 2, wherein the conductive metal structure comprises electrically conductive and heat dissipative materials.

7. The LED light assembly as in claim 6, wherein the conductive metal structure provides a bayonet mount to facilitate removable attachment of the LED light source to a light socket for providing electrical contact to an existing electrical circuit.
